(19) United States
(12) Patent Application Publication
(10) Pub. No.: US 2026/0370075 A1
(43) Pub. Date: Nov. 19, 2026

(54) WINDING WITH COVER PINS

(71) Applicant: ZF FRIEDRICHSHAFEN AG, Friedrichshafen (DE)

(72) Inventor: Stefan REUTER, Hammelburg (DE)

(73) Assignee: ZF FRIEDRICHSHAFEN AG, Friedrichshafen (DE)

(21) Appl. No.: 19/470,563

(22) PCT Filed: Mar. 27, 2024
(86) PCT No.: PCT/EP2024/058258

§ 371 Date: Sep. 29, 2025

(30) Foreign Application Priority Data
Apr. 4, 2023 (DE) 10 2023 203 094.2

(51) Int. Cl. H02K 3/28; H02K 15/067

(52) U.S. Cl. CPC H02K 3/28; H02K 15/067

(57) ABSTRACT

The invention is directed to a winding (1) with hairpins (300) and cover pins (600) for an electric component. The winding (1) extends over an outer layer La, an inner layer Li and a plurality of middle layers Lm, forming a cylindrical circumference of the winding (1). The hairpins (300) are arranged in the middle layers Lm, and there is at least one hairpin (300) per coil strand, the distance between the two conductor members thereof corresponding to a larger pitch deviating from a standard pitch. The middle layers Lm are spanned by cover pins (600) whose two conductor members are arranged in the outer layer La on the one hand and in the inner layer Li on the other hand.

### PRIORITY CLAIM

This is a U.S. national stage of application No. PCT/EP2024/058258, filed on 27 Mar. 2024. Priority is claimed on German Application No. 10 2023 203 094.2, filed: 4 Apr. 2023, the content of which is incorporated herein by reference.

### BACKGROUND OF THE INVENTION

The invention is directed to a winding with hairpins and cover pins for an electric component of an electric machine, such as a stator or a rotor, an electric axle drive and a motor vehicle.

A winding with hairpins, or hairpin winding, is a winding comprising coils which are formed, respectively, by at least one coil strand which in turn comprises a plurality of hairpins which are electrically connected to one another. A hairpin is a shaped bar, generally with a rectangular cross section, having a U-shape with two parallel conductor members which are monolithically connected to one another along a turn region, also known as winding head, and accordingly have two ends on a same side. The ends of the hairpins are electrically conductively connected to one another so that the hairpins are connected in series to form a winding strand. One or more parallel-connected winding strands form a coil. A winding, e.g., of a stator of a two-pole electric machine, comprises three coils, each of which is associated with a phase of the network. The ends of the winding strands which are formed in each instance by a free end of a hairpin terminating the respective winding strand are referred to as connection pins. In the case of winding strands in a lamination stack of a toroidal stator, the hairpins lie in parallel, axially extending slots in a plurality of winding layers. The winding layers comprise at least one radially outer layer, one radially inner layer and a plurality of middle layers.

Each of the slots is associated with a unique position in the lamination stack along the circumference of the lamination stack and can receive the conductor members of a plurality of hairpins which are arranged radially adjacent one another in the slots. The quantity of hairpins arranged in a slot generally corresponds to the quantity of winding layers. The interconnection of the hairpins with one another and with the individual phases and their arrangement in determined slots and determined layers characterize the winding pattern of the winding and, hence, the winding.

A wide variety of windings are known which are advantageously designed for determined requirements of the electric machine. The requirements generally include a smooth operation, low operating noise, prevention of circulating currents and harmonics in the electric machine, and the most uniform possible mutual induction of parallel winding strands, which leads to the most homogeneous possible rotating, superimposed magnetic field.

In describing a winding, the side on which the hairpins are interconnected with one another will be referred to as the twist side. The opposite side, on which the winding heads are located, will be referred to as the turn region side. In order to meet the above-mentioned requirements, hairpins with different coil pitches, for example, can be used in a winding. The coil pitch of a hairpin is determined by the distance between the two slots and by the length of the slots in which the two conductor members of the hairpin are located, the length of the slots being identical. Owing to a varying spacing determined by the quantity of the slots spanned by a hairpin, hairpins with a different coil pitch have different maximum winding head heights. The spacing as it relates to the slots is referred to as pitch and is specified by the quantity of spanned slots plus one. The differing maximum winding head heights result from the fact that the winding heads of the rest of the hairpins are formed in each instance approximately by an isosceles triangle whose equal legs form a same angle with one another regardless of the value of the pitch.

Hairpins with a differing coil pitch, also referred to as pitch, that deviates from a standard coil pitch, also referred to as standard pitch, are used in a coil when the winding has a hole count greater than one. For example, the hole count can amount to three, i.e., there are two or three parallel coil strands which are provided for connecting to a same pole and which are guided in three immediately adjacent slots. Operating noise of the electric machine in which the stator is inserted as well as losses due, for example, to reduced harmonics, are reduced by means of a hole count greater than one. A further reduction of losses can be achieved by changing the winding direction of the coil strands and/or exchanging the arrangement of the coil strands relative to one another, which requires the use of hairpins having a coil pitch that deviates from the standard coil pitch.

A winding with hairpins for an electric component of an electric machine with at least one phase, a hole count of at least three, and two parallel-connected coil strands per phase is known from DE 10 2018 203 471 A1.

The coil strands are formed by a plurality of hairpins which are electrically connected to one another. The conductor member of the hairpin delimiting a coil strand forms a connection pin. The two parallel conductor members of a hairpin have a distance from one another that is determined by the distance of the slots in which the conductor members are inserted when fitting the winding into an electric component, such as a stator. The distance in this case is referred to as a winding step rather than as a pitch, as is usually the case, and is specified by the quantity of spanned slots plus one. The winding step generally corresponds to a standard winding step given by the product of hole count and quantity of phases.

The winding has a cylindrical circumference and is formed by an outer layer, an inner layer and a plurality of middle layers. The two parallel-connected coil strands per phase alternate between two layers for each revolution such that the outer layer forms a double layer with the first middle layer, possibly two further successive middle layers, and the final middle layer forms a double layer with the inner layer.

For each coil strand, there is at least one larger winding step deviating from the standard winding step. The winding head of the hairpin realizing this larger winding step has a maximum winding head height that is greater than the winding heads of a hairpin for a standard winding step.

In one embodiment form, the coil strands have, in a final turn region (winding head) with respect to circumferential direction, a winding step which deviates by two slots from a standard winding step specified, for example, by nine, in order that the coil strands which extend through three slots immediately adjacent one another in circumferential direction are switched between the slot orientations or, more exactly, between the outer slots.

Viewing the winding in its entirety, all of the coil strands pass through the same slot orientations of the same layers exactly the same number of times; only the position in circumferential direction is different. Accordingly, the lengths and the resistance of the winding strands and the amount of induced voltage are identical. A uniform, symmetrical current flow is achieved such that the losses due to mutual induction are reduced. The superimposed rotating magnetic field developing when the winding is energized has a same homogeneity at all times and, therefore, in every rotational angle position.

### SUMMARY OF THE INVENTION

The object of the invention is to provide a winding with hairpins by which the developing superimposed, rotating magnetic field has an even better homogeneity without the winding taking up a larger installation space in axial direction.

For a winding with hairpins for an electric component of an electric machine with at least one phase, a hole count of at least three, and two parallel-connected coil strands per phase, wherein the coil strands have, respectively, at the ends thereof a connection pin and comprise a plurality of series-connected hairpins comprising in each instance two parallel conductor members with two ends on a twist side of the winding and a winding head connecting the conductor members on a turn region side of the winding, wherein the parallel conductor members have a distance from one another that corresponds to a winding step of the winding, and the winding extends over an outer layer, an inner layer and a plurality of middle layers to form a cylindrical circumference of the winding, wherein the winding has, between the outer layer and the inner layer per coil strand, at least one winding step which is a larger winding step deviating from a standard winding step equal to the product of the hole count and the quantity of phases such that the winding head of at least one hairpin per coil strand has a maximum winding head height greater than the winding heads of the other hairpins whose winding step is equal to the standard winding step and which have a maximum standard winding head height, the above-mentioned object is met in that the winding has a plurality of cover pins, with two conductor members and a winding head, wherein one of the conductor members in each instance is arranged in the outer layer and the other of the conductor members is arranged in the inner layer, and the hairpins are arranged in the middle layer, wherein the cover pins span or enclose the middle layers in each instance within an angle range in which the local winding head heights of the winding heads arranged radially one behind the other are smaller than the larger maximum winding head height of a hairpin with a larger winding step minus the thickness of the cover pin in axial direction, so that the cover pins (600) do not project in axial direction beyond the hairpins (300) with a larger winding step (gWS).

The winding steps deviating from the standard winding step are preferably arranged in an angle range over the circumference of the winding in which the connection/return pins are also located, since there are also no cover pins there, and the larger winding head heights of the hairpins having a larger winding step in that area which are located axially one above the other can accordingly protrude from the height of the winding heads with a standard pitch.

The cover pins change the coil strands which otherwise are formed only from hairpins and, therefore, change the current flow in the coil, which influences the magnetic field that is formed. They lead to a further homogenization of the magnetic fields forming around the individual coils and, therefore, of the superimposed magnetic field of the winding.

The installation space height can advantageously be reduced even further when the cover pins span the middle layers in each instance in an angle range in which the local winding head heights of the winding heads which are arranged radially one behind the other are less than the maximum standard winding head height of a hairpin with standard winding step, and a maximum cover pin head height is less than or equal to the larger maximum winding head height (hgₘₐₓ).

The plurality of middle layers advantageously comprise an even number of middle layers, and the hairpins are arranged, respectively, in two of the middle layers which are immediately adjacent one another, forming a double layer.

It is advantageous when the connection pins are formed by I-pins which have only one conductor member, and one end of the conductor member on the twist side is connected to one end of one of the hairpins, and a respective other end on the turn region side forms a free end. Accordingly, the connection pins can be arranged in the inner layer or outer layer and occupy empty spaces therein in which no conductor member of a cover pin is arranged.

The connection pins are advantageously arranged in the outer layer, as a result of which the connection pins can be connected to the power electronics in radial direction, preferably radially adjacent the winding.

It is particularly advantageous in technical respects relating to manufacturing that the ends of all of the hairpins and the ends of the connection pins are deformed, twisted and connected in pairs on the twist side by a same half of a standard pitch or a pitch equal to a standard pitch minus 0.5 or minus 1 and in layers in opposite circumferential direction. This means that in all of the layers, the ends arranged there, each forming a contact region, are deformed over a same length and a same bending path so that they can be deformed simultaneously per layer by a standardized tool.

A stator with a winding according to the invention has the advantages achieved with the winding, as do an electric machine, an electric axle drive, and a motor vehicle in which a winding according to the invention is used.

### BRIEF DESCRIPTION OF THE DRAWINGS

The invention will be described in the following referring to an embodiment example shown in the drawings. The drawings show:

FIG. 1 a portion of a winding inserted into the slots of a stator in a perspective view of the turn region side of the winding;

FIG. 2 a section of a developed view of the winding according to FIG. 1; and

FIG. 3 a portion of the winding inserted into slots of the stator according to FIG. 1 in a perspective view of the twist side of the winding.

### DETAILED DESCRIPTION OF THE PREFERRED EMBODIMENTS

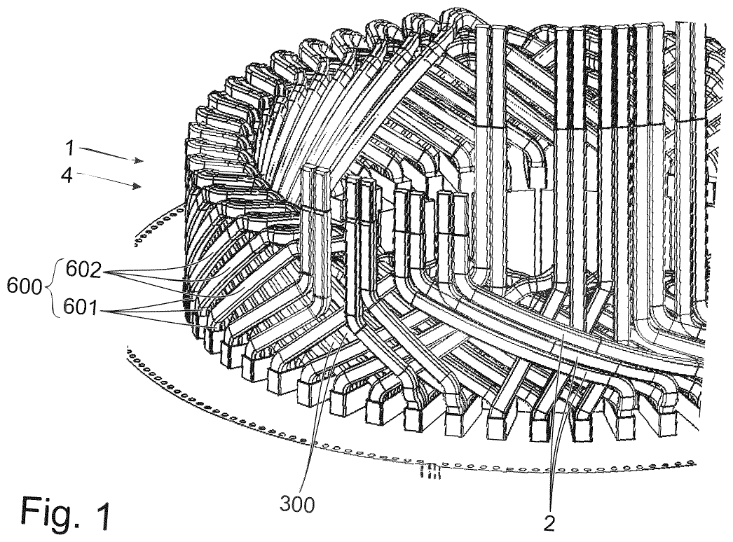

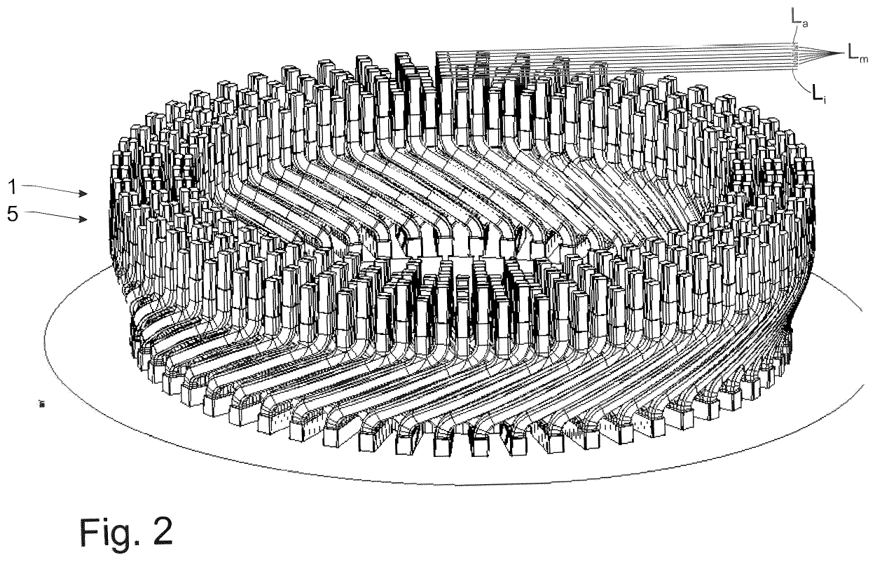

As in the prior art, a winding 1 according to the invention, of which the turn region side is shown in FIG. 1 and the twist side is shown in FIG. 2, has at least one phase, at least one hole count of three, and two parallel-connected coil strands per phase. The winding shown here by way of example has three phases and a hole count of three.

The coil strands contain, in each instance, a plurality of hairpins 300 connected in series. The ends of the coil strands on the turn region side 5 are formed in each instance by a connection pin 2 embodied as an I-pin. The hairpins 300 comprise, in each instance, two parallel conductor members 301 with two ends which, respectively, form a contact region on the twist side 4 and a winding head 302 connecting the conductor members on the turn region side 5. The two parallel conductor members 301 have a distance from one another that corresponds to a pitch.

The winding extends over an outer layer La, an inner layer Li and a plurality of middle layers Lm, in this case exactly four middle layers Lm, and together form the winding 1 with a cylindrical circumference.

The hairpins 300 generally have a standard pitch sWS equal to the product of the hole count and the quantity of phases and, for each coil strand, with at least one exception, a pitch is a larger pitch gWS, which is realized via the winding head 302 of one of the hairpins 300. Accordingly, the winding head 302 of this hairpin has a greater maximum winding head height hgₘₐₓ that is greater than the winding heads 302 of the other hairpins 300 whose pitch is equal to the standard pitch sWS and which have a maximum standard winding head height hsₘₐₓ.

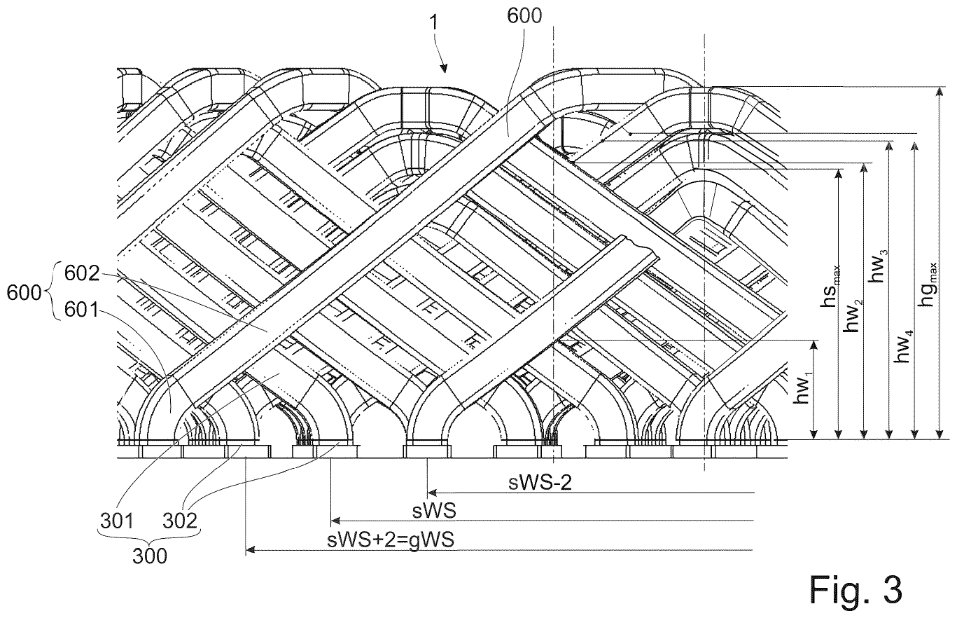

A winding according to the invention differs from a winding known from the prior art particularly in that the hairpins 300 between the outer layer La and the inner layer Li are arranged only on the middle layers Lm, and the winding 1 has a plurality of cover pins 600 with two conductor members 601 and a winding head 602, one of the conductor members 601 being arranged in the outer layer La and the other of the conductor members 602 being arranged in the inner layer Li, and the cover pins 600 span the middle layers Lm. It is key to the invention that the cover pins 600 span the middle layers in each instance in an angle range in which the local winding head height hw of the winding heads 302 which are arranged radially one behind the other is less than the larger maximum winding head height hgₘₐₓ of a hairpin 300 with a larger winding step gWS minus the thickness of the cover pin 600 in axial direction. In the developed view shown in FIG. 3, the angle range corresponds to the region between the two dash-dot lines. The local winding head heights hw are given as hw₁-hw₃ at three winding heads, one each of four middle layers Lm. The cover pin 600 designated by reference numeral 600 first spans a middle layer Lm at a point where the highest of the three winding heads 302 arranged axially one above the other in this layer has a local winding head height hw₁. It then spans the radially outwardly adjoining middle layer at the point where three further winding heads 302 are arranged axially one above the other, the highest of which has a local winding head height hw₂. Before the cover pin 600 spans the radially outermost fourth middle layer Lm, where a highest winding head height hw₄ is given, it spans the third middle layer Lm where the highest winding head height hw₃ is given.

The actual values of the local winding head heights hw1-hw4 cannot be discerned from FIG. 3; rather, it is intended to show merely that the values are less than the amount of a maximum cover pin head height hcₘₐₓ of the cover pin at that location where the cover pin 600 spans the individual middle layers Lm. In the angle range where it spans the middle layers Lm, the winding head 602 of the cover pin 600 has a flattened top with an at least approximately constant height, i.e., the maximum cover pin head height hcₘₐₓ, which is less than or equal to the larger maximum winding head height hgₘₐₓ. To this end, the angle range in which the cover pin 600 spans the middle layers Lm is selected such that hw1-hw4 are less than the larger maximum winding head height hgₘₐₓ. More precisely, hw1-hw4 are smaller by at least the thickness of the cover pin 600 in axial direction than the larger maximum winding head height hgₘₐₓ.

In the section of a developed view of the winding shown in FIG. 3, it is clearly visible for two phases in two middle layers how the winding heads of the hairpins 300 protrude with three parallel conductor members from three adjacent slots on the left-hand side and dip into three adjacent slots on the right-hand side. The conductor members change their position in the outer slots so that the two hairpins 300 in question have a pitch that deviates from the standard-r pitch sWS and lie one above the other in axial direction. The offset of the coil strands of the two phases by three slots results in a valley therebetween in which the cover pin 600 can span at least the two middle layers Lm without increasing the overall height of the winding 1 on the turn region side 5.

As can be seen from FIG. 1, the connection pins 2 on the turn region side 5 protrude from the slots. The connection pins 2 are formed by I-pins. They have, in each instance, only one conductor member, with one end of the conductor member on the twist side 4 connected to one end of one of the hairpins 300 and another end on the turn region side 5 forming a free end. Since the connection pins 2 protrude from the slots in the outer layer La and, viewed radially, also remain in this layer, they are preferably arranged in angle ranges in which the conditions stipulated for the angle ranges for spanning with the cover pins 600 are not met.

On the twist side 4, shown in FIG. 2, the ends of the hairpins forming the contact regions are deformed, twisted, and connected to one another in pairs by a same half standard pitch sWS and in layers in the opposite circumferential direction.

1. A winding with hairpins for an electric component of an electric machine with at least one phase, a hole count of at least three, and two parallel-connected coil strands per phase, wherein the coil strands have, respectively, at the ends thereof a connection pin and comprise a plurality of series-connected hairpins comprising in each instance two parallel conductor members with two ends on a twist side of the winding and a winding head connecting the conductor members on a turn region side of the winding, wherein the parallel conductor members have a distance from one another that corresponds to a pitch of the winding and the winding-extends over an outer layer (La), an inner layer (Li) and a plurality of middle layers (Lm) to form a cylindrical circumference of the winding wherein the winding has, between the outer layer (La) and the inner layer (Li) per coil strand, at least one pitch which is a larger pitch deviating from a standard pitch equal to the product of the hole count and the quantity of phases such that the winding head of at least one hairpin per coil strand has a larger maximum winding head height (hgₘₐₓ) greater than the winding heads of the other hairpins whose pitch is equal to the standard pitch (sWS) and which have a maximum standard winding head height (hsₘₐₓ), wherein the winding has a plurality of cover pins with two conductor members and a winding head, wherein one of the conductor members in each instance is arranged in the outer layer (La) and the other of the conductor members is arranged in the inner layer (Li), and the hairpins are arranged in the middle layer (Lm), wherein the cover pins span the middle layers (Lm) in each instance in an angle range in which the local winding head heights (hw) of the winding heads arranged radially one behind the other are smaller than the larger maximum winding head height (hgₘₐₓ) of a hairpin with larger pitch (gWS) minus a thickness of the cover pin in axial direction, so that the cover pins do not project in axial direction beyond the hairpins with a larger pitch (gWS).

2. The winding according to claim 1, wherein the cover pins span the middle layers (Lm) of the winding in each instance in an angle range in which the local winding head heights (hw) of the winding heads which are arranged radially one behind the other are less than the maximum standard winding head height (hsₘₐₓ) of a hairpin with standard pitch (sWS), and a maximum cover pin head height is less than or equal to the larger maximum winding head height (hgₘₐₓ).

3. The Winding according to claim 1, wherein the plurality of middle layers (Lm) comprises an even number of middle layers (Lm), and the hairpins are arranged, respectively, in two of the middle layers (Lm) which are immediately adjacent one another, forming a double layer.

4. The winding according to claim 1, wherein the connection pins are formed by I-pins which have only one conductor member, wherein one end of the conductor member on the twist side is connected to one end of one of the hairpins, and a respective other end on the turn region side forms a free end.

5. The winding according to claim 4, wherein the connection pins are arranged in the outer layer (La).

6. The winding according to claim 4 wherein, the ends of all of the hairpins and the ends of the connection pins are deformed, twisted and connected in pairs on the twist side by a same half of a standard pitch (sWS) and in layers in opposite circumferential direction.

7. The winding according to claim 4, wherein the ends of all of the hairpins and the ends of the connection pins are deformed, twisted and connected in pairs on the twist side by a pitch equal to one half of a standard pitch (sWS) minus 1 and in layers in opposite circumferential direction.

8. The winding according to claim 4, wherein the ends of all of the hairpins and the ends of the connection pins are deformed, twisted and connected in pairs on the twist side by a pitch equal to one half of a standard pitch (sWS) minus 0.5 and in layers in opposite circumferential direction.

9. A stator for an electric machine, wherein the stator is provided with a winding according to claim 1.

10. An electric machine, having a stator according to claim 9.

11. An electric axle drive, having an electric machine according to claim 10.

12. A motor vehicle, having an electric axele drive according to claim 11.
